(19) United States
(12) Patent Application Publication
(10) Pub. No.: US 2024/0143863 A1
(43) Pub. Date: May 2, 2024

(54) METHOD AND SYSTEM FOR INTERACTIVELY CREATING, EXECUTING, AND MANAGING DESIGN FOR EXCELLENCE (DFX) RULES

(71) Applicant: HCL Technologies Limited, New Delhi (IN)

(72) Inventor: ROMESH AGRAWAL, Pune (IN)

(21) Appl. No.: 18/097,342

(22) Filed: Jan. 16, 2023

(30) Foreign Application Priority Data
Nov. 1, 2022 (IN) 202211062400

(51) Int. Cl. G06F 30/20; G06F 30/12

(52) U.S. Cl. CPC G06F 30/20; G06F 30/12; G06F 2119/02

(57) ABSTRACT

This disclosure relates to method and system for interactively creating, executing, and managing Design for Excellence (DFX) rules for 3-Dimensional (3D) Computer Aided Design (CAD) models. The method may include receiving rule definition data corresponding to a DFX rule for a process associated with the 3D CAD model from a subject matter expert through a Graphical User Interface (GUI). The rule definition data include basic details, definition criteria, and default configuration. Each of the basic details, the definition criteria, and the default configuration include a plurality of data elements. The method may further include defining parameter expressions with a set of supported parameters for the process using a set of parameter data components of the process. The method may further include generating a rule definition file for the DFX rule based on the rule definition data and the set of supported parameters obtained from the DFX rule builder.

### TECHNICAL FIELD

This disclosure relates generally to Design for Excellence (DFX), and more particularly to method and system for interactively creating, executing, and managing DFX rules for 3-Dimensional (3D) Computer Aided Design (CAD) models.

### BACKGROUND

Design for Excellence (DFX), also known as Design for X, is an engineering practice and a designing approach for a product or process where X is a target variable (i.e., an objective) to be optimized in design. Based on ‘X’, DFX may take a form of Design for Manufacture (DFM), Design for Assembly (DFA), Design for Manufacture and Assembly (DFMA), Design for Cost/Procurement (DFC/DFP), Design for Reliability (DFR), Design for Quality (DFQ), Design for Maintenance, Design for Testability (DFT), Design for Supply Chain (DFSC), Design for Sustainability (DFS), etc.

Design for manufacturing and assembly (DFMA) is a type of DFX method which helps to design products that are easy to manufacture and assemble, helps in reduction of product cost, and time-to-market. DFMA helps to find potential downstream issues in an early stage of design and development, so that corrective actions can be taken during initial phases of product design. This helps to improve product quality and reduce cost, and time-to-market. Industries across different sectors are expanding and creating more complex designs. Global competitions are also forcing organizations to build higher quality product at faster pace. DFMA practice plays an important role in achieving such goals that help in identifying the potential manufacturing and assembly related issues at early stages of product development cycle. DFMA also helps organizations to know if there are any opportunity to reduce the cost of the product at the initial stages of design by using some good cost-to-design practices. Over the last three decades, DFMA has evolved and is now becoming an indispensable process for many organizations. It is mostly driven by competitive market where product quality, time-to-market, and cost are differentiating factors. DFMA analysis can be performed manually by leveraging the expertise of experienced people in the field, automatically with the help of software tools available in the market, or semi-automatically. Software tools also help in capturing the knowledge from experienced people in the form of rules, which can be kept in the central knowledge repository and leveraged by novice designers. These tools also provide framework to capture best global practices and knowledge within organization which can be utilized for DFMA analysis.

DFMPro® software is a tool, which automates DFX analysis on 3D CAD models. It is integrated seamlessly with major 3D CAD systems like Siemens NX, PTC Creo Parametric, and Dassault Systems SOLIDWORKS. It comes with more than 250 OOTB checks for various manufacturing processes like injection-molding, machining, sheet metal, sand-casting, die-casting, additive, tubing, composite machining, thermoforming, forging, vacuum-forming, and assembly. Many organizations using DFMPro® also need custom rules for various reasons such as, rules may be proprietary to them, rules may be relevant to a specific organization, and sometimes they need to develop custom rules at faster pace based on their priorities. DFMPro® provides API Toolkit which is used by some of the organization to develop custom rules. Once, custom rules are created, they can be configured as per organization's needs and standards using DFMPro® Rule Manager application, which is used to configure both OOTB and custom rules, and then executed in DFMPro® plug-in on respective CAD systems. DFMPro® has two main applications—one is DFMRuleManager, which is an authoring application to select and configure OOTB and custom rules as per the organization's need. Rule configuration for all the rules is saved in DFXRule file and used during DFX analysis. Second application is DFMPro® Plug-in, which is integrated with respective CAD applications and provides GUI, and workflow for DFX analysis. It performs DFX analysis and shows all the identified issues along with recommendation to address those issues.

In the present state of art, creating custom rules for DFX require a programmer with exposure to programming languages, development tools (e.g., integrated development environment (IDE)), API Toolkit, and knowledge about the domain in which rules need to be developed. This process is time consuming due to nature of approach, and may take up to a week to a couple of weeks depending on the rule complexity. This also leads to higher cost for development and maintenance of custom rules. Many organizations do not have a dedicated team of expert programmers with all the required skill-sets. Many times, it is also not a cost-effective option to develop and maintain custom rules. A small modification in already created rules cannot be done by a subject matter expert and requires intervention from a developer. Such challenges lead to a big problem for an organization in extending the DFMPro® software.

There is, therefore, a need in the present state of art for a generic framework to build and execute DFX rules interactively without a requirement of computer programming skills.

### SUMMARY

In one embodiment, a method for interactively creating, executing, and managing Design for Excellence (DFX) rules for 3-Dimensional (3D) Computer Aided Design (CAD) models is disclosed. In one example, the method may include receiving, by a DFX rule builder, rule definition data corresponding to a DFX rule for a process associated with the 3D CAD model from a subject matter expert through a Graphical User Interface (GUI). The rule definition data may include basic details, definition criteria, and default configuration. Each of the basic details, the definition criteria, and the default configuration may include a plurality of data elements. The method may further include defining, by the DFX rule builder, parameter expressions with a set of supported parameters for the process using a set of parameter data components of the process. The method may further include generating, by a rule definition writer, a rule definition file for the DFX rule based on the rule definition data and the set of supported parameters obtained from the DFX rule builder.

In one embodiment, a system for interactively creating, executing, and managing DFX rules for 3D CAD models is disclosed. In one example, the system may include a processor and a computer-readable medium communicatively coupled to the processor. The computer-readable medium may store processor-executable instructions, which, on execution, may cause the processor to receive, by a DFX rule builder, rule definition data corresponding to a DFX rule for a process associated with the 3D CAD model from a subject matter expert through a GUI. The rule definition data may include basic details, definition criteria, and default configuration. Each of the basic details, the definition criteria, and the default configuration may include a plurality of data elements. The processor-executable instructions, on execution, may further cause the processor to define, by the DFX rule builder, parameter expressions with a set of supported parameters for the process using a set of parameter data components of the process. The processor-executable instructions, on execution, may further cause the processor to generate, by a rule definition writer, a rule definition file for the DFX rule based on the rule definition data and the set of supported parameters obtained from the DFX rule builder.

In one embodiment, a non-transitory computer-readable medium storing computer-executable instructions for interactively creating, executing, and managing DFX rules for 3D CAD models is disclosed. In one example, the stored instructions, when executed by a processor, cause the processor to perform operations including receiving, by a DFX rule builder, rule definition data corresponding to a DFX rule for a process associated with the 3D CAD model from a subject matter expert through a GUI. The rule definition data may include basic details, definition criteria, and default configuration. Each of the basic details, the definition criteria, and the default configuration may include a plurality of data elements. The operations may further include defining, by the DFX rule builder, parameter expressions with a set of supported parameters for the process using a set of parameter data components of the process. The operations may further include generating, by a rule definition writer, a rule definition file for the DFX rule based on the rule definition data and the set of supported parameters obtained from the DFX rule builder.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for interactively creating, executing, and managing Design for Excellence (DFX) rules for 3-Dimensional (3D) Computer Aided Design (CAD) models, in accordance with some embodiments.

FIG. 2 illustrates a flow diagram of an exemplary control logic for interactively creating DFX rules for 3D CAD models, in accordance with some embodiments.

FIG. 3 illustrates various data elements of rule definition data, in accordance with some embodiments.

FIGS. 4A-B illustrate a flow diagram of an exemplary process for interactively creating, executing, and managing DFX rules for 3D CAD models, in accordance with some embodiments.

FIG. 5 is a block diagram of an exemplary system for interactively creating DFX rules for 3D CAD models, in accordance with some embodiments.

FIG. 6 is a block diagram of an exemplary system for executing DFX rules for 3D CAD models, in accordance with some embodiments.

FIG. 7 is a block diagram of an exemplary system for interactively modifying DFX rules for 3D CAD models, in accordance with some embodiments.

FIG. 8 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

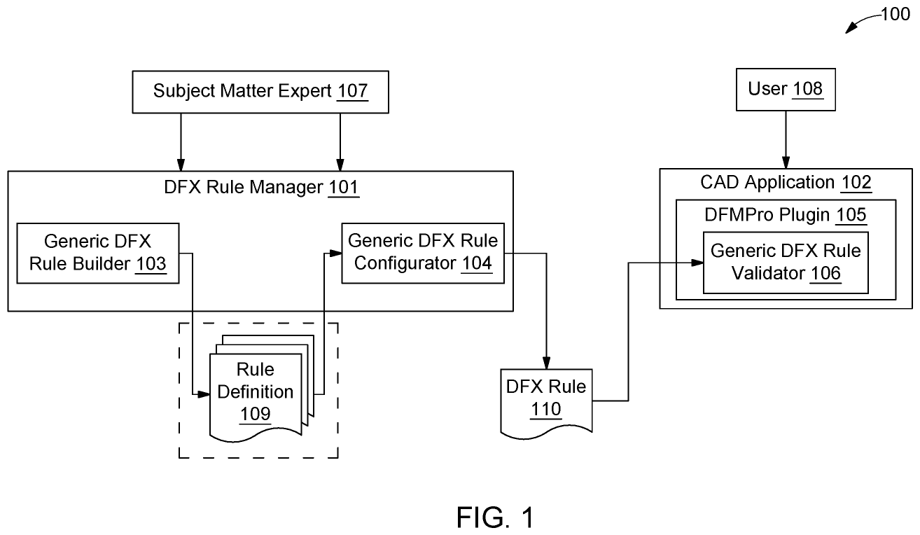

Referring now to FIG. 1, an exemplary system 100 for interactively creating, executing, and managing Design for Excellence (DFX) rules for 3-Dimensional (3D) Computer Aided Design (CAD) models is illustrated, in accordance with some embodiments. The system 100 may implement within a computing device (for example, server, desktop, laptop, notebook, netbook, tablet, smartphone, mobile phone, or any other computing device), in accordance with some embodiments of the present disclosure. As will be appreciated, DFX (also known as Design for X) is a designing approach for a product or process where X is a target variable (i.e., an objective) to be optimized in design. By way of an example, DFX may be Design for Manufacture (DFM), Design for Assembly (DFA), Design for Manufacture and Assembly (DFMA), Design for Cost/Procurement (DFC/DFP), Design for Reliability (DFR), Design for Quality (DFQ), Design for Maintenance, Design for Testability (DFT), Design for Supply Chain (DFSC), Design for Sustainability (DFS), or the like.

In some embodiments, the system 100 may include one or more processors (not shown in figure) and a computer-readable medium (for example, a memory). The computer-readable storage medium may store instructions that, when executed by the one or more processors, cause the one or more processors to interactively create and manage DFX rules for 3D CAD models, in accordance with aspects of the present disclosure. The system 100 may implement, via the computer-readable medium, a DFX rule manager 101 and a CAD application 102. Further, the DFX rule manager 101 may include a generic DFX rule builder 103 and a generic DFX rule configurator 104. The CAD application 102 may include a DFMPro plugin 105 that may be configured to implement a generic DFX rule validator 106. The DFMPro plugin 105 may be a component of a DFX application that may allow the subject matter expert to create and validate DFX rules interactively.

The system 100 may further include a display (not shown in the figure). The system 100 may interact with a user via a Graphical User Interface (GUI) accessible via the display. The DFX rule manager 101 may be accessible to a subject matter expert 107 via the GUI. The system 100 may also include one or more external devices (not shown in the figure). In some embodiments, the system 100 may interact with the one or more external devices over a communication network for sending or receiving various data. The external devices may include, but may not be limited to, a remote server, a digital device, or another computing system. In some embodiments, the CAD application 102 may be executed via an external device. Alternatively, the CAD application 102 may be executed on same device as the DFX rule manager 101. The CAD application 102 may be accessible to a user 108 via a GUI.

The subject matter expert 107 may provide rule definition data to the DFX rule manager 101 via the GUI to interactively create and manage DFX rules for 3D CAD models. It may be noted that the rule definition data may include basic details, definition criteria, and default configuration. Additionally, each of the basic details, the definition criteria, and the default configuration may include a plurality of data elements. The user 108 may use the DFMPro Plugin 105 in the CAD application 102 to implement the DFX rules created by the subject matter expert 107.

The subject matter expert 107 may open the DFX rule manager 101 in the GUI and may use the generic DFX rule builder 103 to interactively create a new DFX rule by providing inputs corresponding to the rule definition data and save the rule definition data to a rule definition file 109 in a database. Further, the subject matter expert 107 may open the DFX rule in the DFX rule manager 101 to configure the DFX rule using the generic DFX rule configurator 104 based on requirements and standards of an organization. Further, the subject matter expert may save the configured DFX rule in a DFX rule file 110. It should be noted that the DFX rule file 110 may include configuration information of the DFX rule. Further, the user 108 may execute or analyze the DFX rule by using the DFX rule file 110 in the DFMPro plugin 105 using the generic DFX rule validator 106 within the CAD application 102. For example, the generic DFX rule validator 106 may evaluate the plurality of data elements of the rule definition data in the DFX rule file 110.

It should be noted that all such aforementioned modules 101-106 may be represented as a single module or a combination of different modules. Further, as will be appreciated by those skilled in the art, each of the modules 101-106 may reside, in whole or in parts, on one device or multiple devices in communication with each other. In some embodiments, each of the modules 101-106 may be implemented as dedicated hardware circuit comprising custom application-specific integrated circuit (ASIC) or gate arrays, off-the-shelf semiconductors such as logic chips, transistors, or other discrete components. Each of the modules 101-106 may also be implemented in a programmable hardware device such as a field programmable gate array (FPGA), programmable array logic, programmable logic device, and so forth. Alternatively, each of the modules 101-106 may be implemented in software for execution by various types of processors. An identified module of executable code may, for instance, include one or more physical or logical blocks of computer instructions, which may, for instance, be organized as an object, procedure, function, or other construct. Nevertheless, the executables of an identified module or component need not be physically located together, but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for interactively creating, executing, and managing DFX rules for 3D CAD models. For example, the exemplary system 100 may interactively create and manage DFX rules for 3D CAD models by the processes discussed herein. In particular, as will be appreciated by those of ordinary skill in the art, control logic and/or automated routines for performing the techniques and steps described herein may be implemented by the system 100 either by hardware, software, or combinations of hardware and software. For example, suitable code may be accessed and executed by the one or more processors on the system 100 to perform some or all of the techniques described herein. Similarly, application specific integrated circuits (ASICs) configured to perform some or all of the processes described herein may be included in the one or more processors on the system 100.

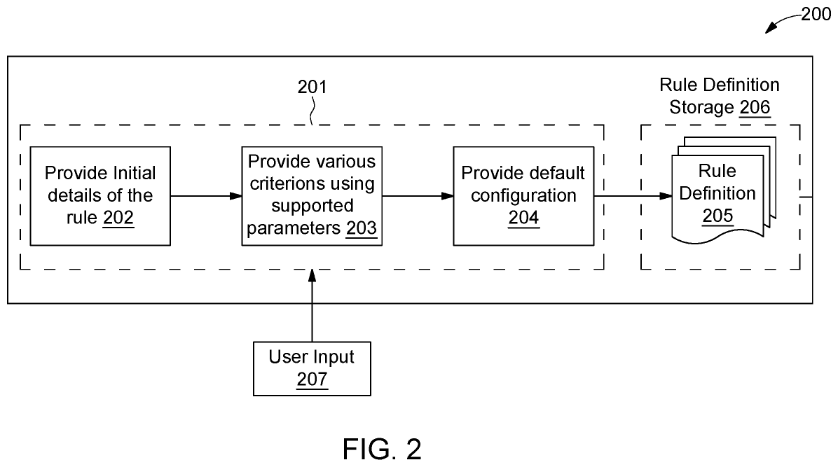

Referring now to FIG. 2, an exemplary control logic 200 for interactively creating DFX rules for 3D CAD models is depicted via a flow chart, in accordance with some embodiments.

The control logic 200 may be implemented in a system (such as, the system 100) including a generic DFX rule builder 201. The generic DFX rule builder 201 may be analogous to the generic DFX rule builder 103 of the system 100.

The control logic 200 may include providing initial details of a DFX rule, at step 202. Further, the control logic 200 may include providing various criteria using supported parameters, at step 203. Further, the control logic 200 may include providing default configuration, at step 204. The data provided to the DFX rule builder 201 through the steps 202-204 (i.e., rule definition data) may be stored as rule definition file 205 in a rule definition storage 206. The steps 202-204 are explained in detail below.

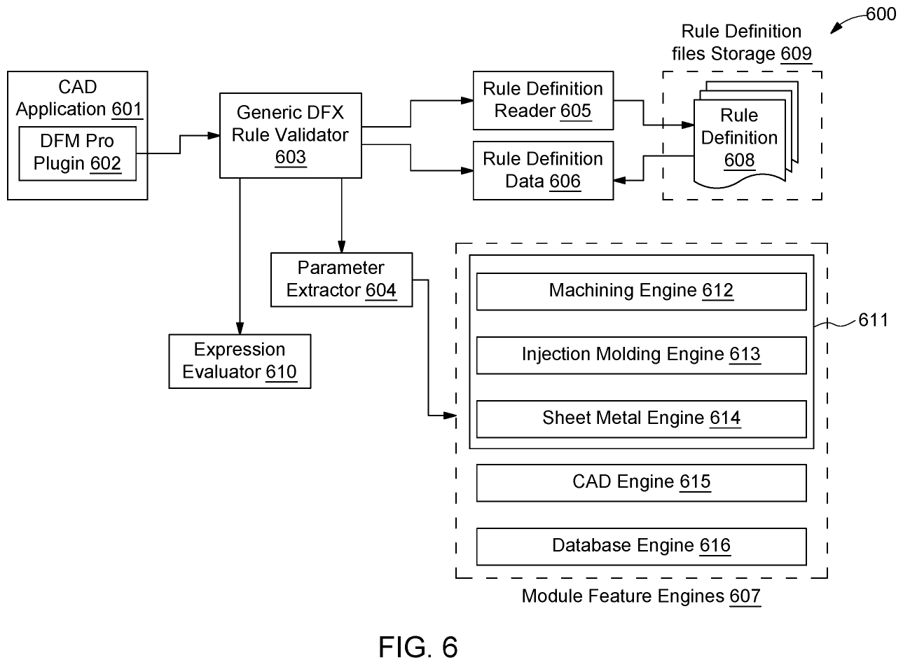

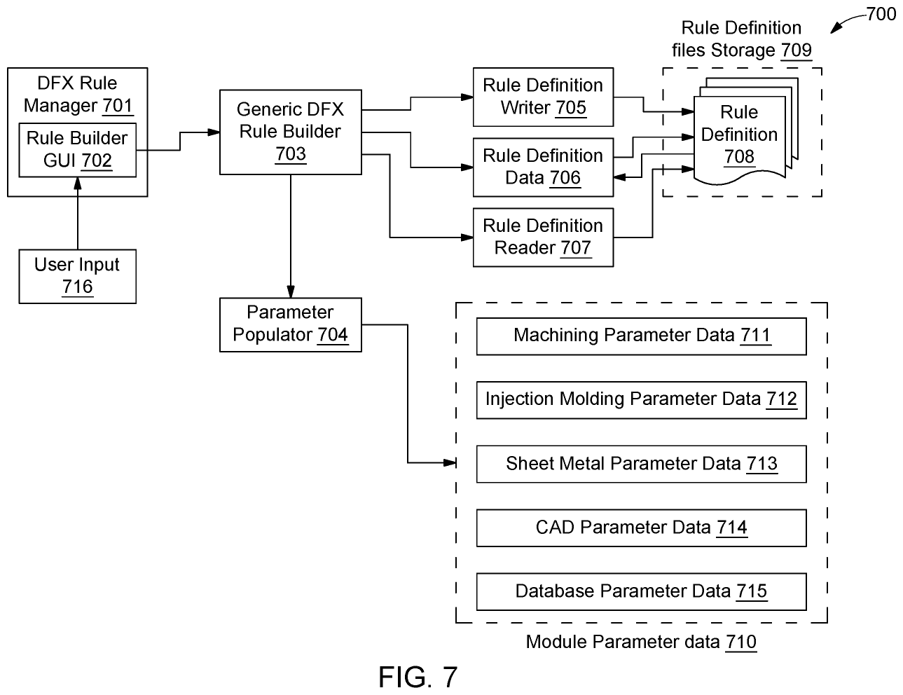

The generic DFX rule builder 201 may include a GUI displaying a set of UI controls for a user to provide user input 207 required to define a DFX rule completely. As explained in conjunction with FIG. 1, the user input 207 may include basic details, definition criteria, and default configuration. It should be noted that the user may refer to a subject matter expert or any other CAD user. At step 202, the user may provide basic or initial information about the DFX rule including rule name, rule module, criticality, rule importance, rule help, rule summary, feature, etc. Further, based on the rule module and feature selected by the user, the GUI may display a set of supported parameters. At step 203, the user may define various filtering, condition, and validation criteria for the DFX rule by defining the expressions using each of the set of supported parameters based on the selected module and feature. Further, the framework may perform various checks to validate whether the DFX rule is completely and properly defined and may request the user for any modification, if needed, to define a rule correctly and completely. At step 204, the user may provide default configuration for the created DFX rule, which may also be modified later during DFX rule configuration (explained in detail in conjunction with FIGS. 7 and 6). Thereafter, the rule definition data may be saved into a rule definition file 205 in rule definition storage 206. By way of an example, the rule definition storage 206 may be a file directory or a database.

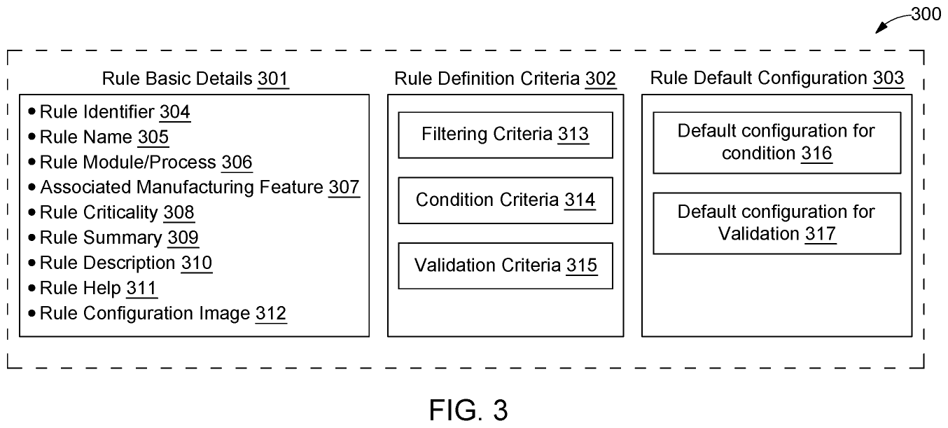

Referring now to FIG. 3, various data elements of rule definition data 300 are illustrated, in accordance with some embodiments. The rule definition data 300 may include rule basic details 301, rule definition criteria 302, and rule default configuration 303. Further, each of the rule basic details 301, rule definition criteria 302, and rule default configuration 303 may include a plurality of data elements.

The rule basic details 301 may include a plurality of data elements which may represent various attributes of a DFX rule and may not be related to any parameter. By way of an example, the plurality of data elements for the rule basic details 301 may include, but may not be limited to, a rule identifier 304, a rule name 305, a rule module/process 306, an associated manufacturing feature 307, a rule criticality 308, a rule summary 309, a rule description 310, a rule help 311, and a rule configuration image 312.

The rule definition criteria 302 may depend on multiple parameters through which various criteria of a DFX rule may be defined for filtering, condition, and validation. The rule definition criteria 302 may be defined using such multiple parameters (e.g., parameters associated with feature, CAD model, or standards stored in database) and operators. It may be noted that a parameter may be defined with a name, a symbol, an associated feature, a value type (i.e., numeric, logical, floating point, or string), and a supported operator (i.e., less than, greater than, equal to, range, not equal to, etc.) based on the value type of the parameter. By way of an example, the plurality of data elements for the rule definition criteria 302 may include, but may not be limited to, filtering criteria 313, condition criteria 314, and validation criteria 315.

The rule definition criteria 302 may define complete logic and behavior of a DFX rule. The filtering criteria 313 for a DFX rule may be optional and may be defined to add one or more filtering criteria in the DFX rule. The condition criteria 314 for a DFX rule may also be optional and may be defined when recommendation for the DFX rule may change with one or more conditions. The validation criteria 315 are mandatory for a DFX rule (i.e., the DFX rule is required to include at least one validation criterion) as the DFX rule is primarily about evaluating certain information in a CAD model. The validation criteria 315 may define evaluation to be performed by the DFX rule.

In some exemplary scenarios, although optional, some real-time DFX rules may require the filtering criteria 313 and the condition criteria 314. The filtering criteria 313 is a part of definition of the DFX rule and cannot be configured after creation of the DFX rule. However, the condition criteria 314 and the validation criteria 315 may be configured as per an organization's need. Parameter expressions may be defined using one or more parameters and/or constant value, and one or more mathematical operators (e.g., depth, depth/radius, radius+thickness/2.0, etc.).

The rule default configuration 303 defined for the DFX rule may be provided by the user (such as, the user 108). The rule default configuration 303 may include recommended values and operators corresponding to the DFX rule. By way of an example, the plurality of data elements for the rule default configuration 303 may include, but may not be limited to, default configuration for condition 316 and default configuration for validation 317.

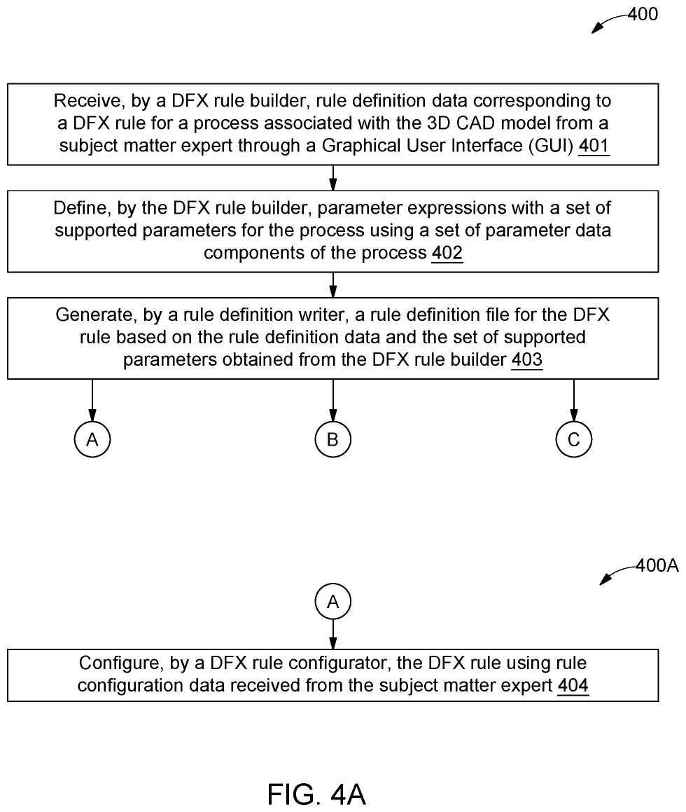

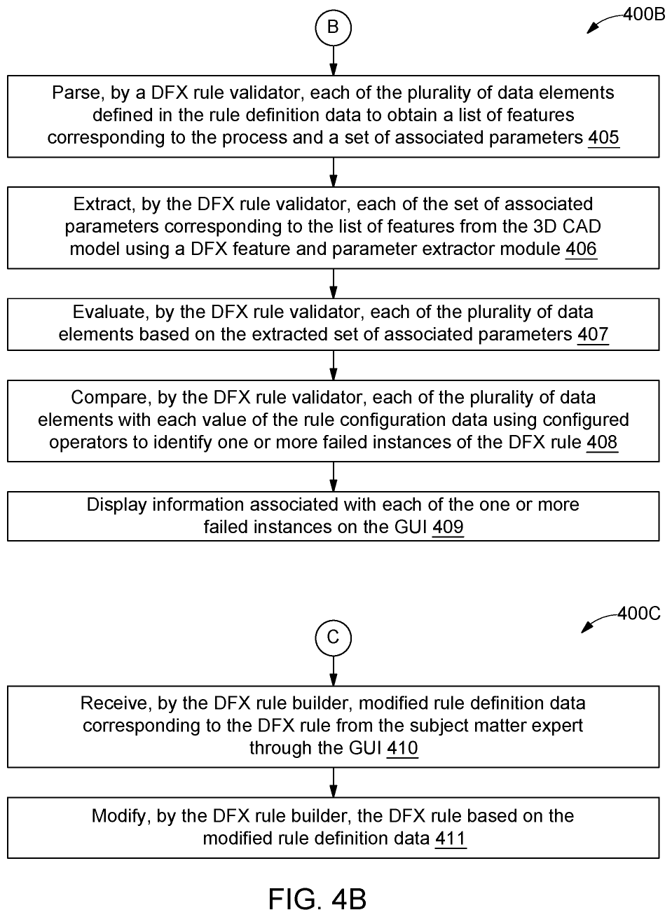

Referring now to FIGS. 4A-B, an exemplary process 400 for interactively creating and managing DFX rules for 3D CAD models is depicted via a flowchart, in accordance with some embodiments. In an embodiment, the process 400 may be implemented by the system 100. The process 400 may include receiving, by a DFX rule builder (such as, the generic DFX rule builder 103), rule definition data corresponding to a DFX rule for a process associated with the 3D CAD model from a subject matter expert through a GUI, at step 401. The rule definition data may include basic details, definition criteria, and default configuration. Each of the basic details, the definition criteria, and the default configuration may include a plurality of data elements. Examples of the plurality of data elements for each of the basic details, the definition criteria, and the default configuration have been provided in conjunction with FIG. 3.

Further, the process 400 may include defining, by the DFX rule builder, parameter expressions with a set of supported parameters for the process using a set of parameter data components of the process, at step 402. Further, the process 400 may include generating, by a rule definition writer, a rule definition file for the DFX rule based on the rule definition data and the set of supported parameters obtained from the DFX rule builder, at step 403. By way of an example, a subject matter expert may select a process or a feature of a CAD model through the GUI of the generic DFX rule builder 103. The GUI may then provide a plurality of input options corresponding to the selected process or feature of the CAD model to the subject matter expert. Each of the plurality of input options may require an input corresponding to rule definition data of the DFX rule. Upon receiving the required rule definition data from the subject matter expert, the GUI may define parameter expressions with a set of supported parameters corresponding to the selected process or feature using a set of parameter data components. Further, based on the rule definition data and the set of supported parameters, the generic DFX rule builder 103 may generate a rule definition file corresponding to the DFX rule.

In some embodiments, the process 400 may include storing, by the rule definition writer, the rule definition file for the DFX rule in a database. In such embodiments, the process 400 may further include retrieving, by a rule definition reader, each of the rule definition data of the DFX rule from the rule definition file or the database. Further, the process 400 may implement one or more of 3 subprocesses 400A (a process for configuring the rule definition data), 400B (a process for validating the plurality of data elements), and 400C (a process for modifying the DFX rule).

The subprocess 400A may include configuring, by a DFX rule configurator (such as, the generic DFX rule configurator 104), the DFX rule using rule configuration data received from the subject matter expert, at step 404. By default, when the DFX rule file is generated, the DFX rule may include the default configuration. However, the subject matter expert may modify the default configuration via the DFX rule configurator.

The subprocess 400B may include parsing, by a DFX rule validator (such as, the generic DFX rule validator 106), each of the plurality of data elements defined in the rule definition data to obtain a list of features corresponding to the process and a set of associated parameters, at step 405. Further, the subprocess 400B may include extracting, by the DFX rule validator, each of the set of associated parameters corresponding to the list of features from the 3D CAD model using a DFX feature and parameter extractor module, at step 406. Further, the subprocess 400B may include evaluating, by the DFX rule validator, each of the plurality of data elements based on the extracted set of associated parameters, at step 407. Further, the subprocess 400B may include comparing, by the DFX rule validator, each of the plurality of data elements with each value of the rule configuration data using configured operators to identify one or more failed instances of the DFX rule, at step 408.

Further, the subprocess 400B may include displaying information associated with each of the one or more failed instances on the GUI, at step 409. In an embodiment, the GUI may be a DFMPro® GUI.

The subprocess 400C may include receiving, by the DFX rule builder, modified rule definition data corresponding to the DFX rule from the subject matter expert through the GUI, at step 410. Further, the subprocess 400C may include modifying, by the DFX rule builder, the DFX rule based on the modified rule definition data, at step 411.

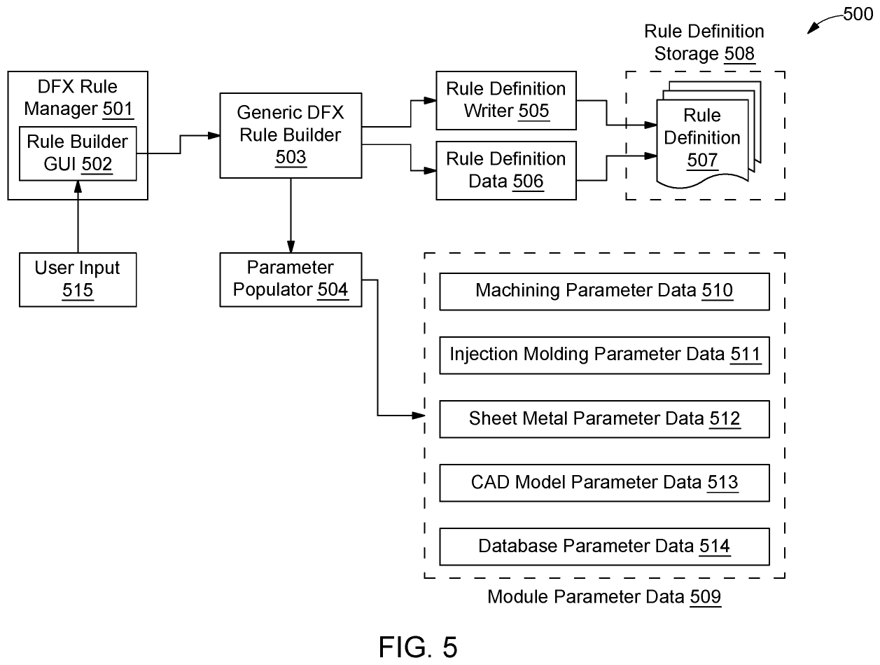

Referring now to FIG. 5, a block diagram of an exemplary system 500 for interactively creating DFX rules for 3D CAD models is illustrated, in accordance with some embodiments.

The system 500 may include a DFX rule manager 501. In an embodiment, the DFX rule manager 501 may be a standalone application. The DFX rule manager 501 may include a rule builder GUI 502. Further, the system 500 may include a generic DFX rule builder 503, a parameter populator 504, a rule definition writer 505, rule definition data 506, a rule definition file 507 stored in a rule definition storage 508, and parameter data module 509. By way of an example, the parameter data module 509 may include modules or data components that may correspond to, but may not be limited to, machining parameter data 510, injection molding parameter data 511, sheet metal parameter data 512, CAD model parameter data 513, and database parameter data 514.

It should be noted that ‘generic’ implies that same components may be used to build DFX rules for all type of manufacturing processes in contrast to a conventional API-based approach, where process-specific components need to be implemented. A subject matter expert may launch the rule builder GUI 502 from the DFX rule manager 501. The rule builder GUI 502 may provide user interface controls to a user. Further, the user may provide or select user input 515 corresponding to rule definition data required to completely define a DFX rule. It may be noted that the user input 515 may include basic rule details such as, rule name, rule module, rule description, rule summary, rule criticality, feature based on which the rule is to be defined, help description to explain rule importance, image for rule configuration, etc. Additionally, the user input 515 may include expressions defined using various parameters related to the CAD model and features.

The rule builder GUI 502 may display various available inputs and parameters which are supported by the framework and corresponding to which, the user may provide the user input 515. The rule builder GUI 502 may receive the available inputs and parameters for display from the generic DFX rule builder 503. Further, the DFX rule manager 501 may send the user input 515 to the generic DFX rule builder 503. The generic DFX rule builder 503 may store the user input 515 as the rule definition data 506, Further, the generic DFX rule builder 503 may write the rule definition data 506 to the rule definition file 507 through the rule definition writer 505. The rule definition file 507 may be stored in the rule definition storage 508. It may be noted that the rule definition storage 508 may be a physical storage (for example, a file directory or a database).

For a DFX process selected by the user, the generic DFX rule builder 503 may receive supported parameters corresponding to the DFX process using the parameter populator 504. The parameter populator 504 may obtain the supported parameters based on the selected DFX process and may obtain features using the various data modules of parameter data module 509. For example, the parameter populator 504 may obtain supported CAD model features and parameters which are used for manufacturing processes using the CAD model parameter data 513 module. The machining parameter data 510 module may provide a list of supported machining features (e.g., hole, pocket, chamfer, fillet, etc.) and associated parameters based on which a DFX rule may be defined. Similarly, injection molding parameter data 511 module and sheet metal parameter data 512 module may provide injection molding and sheet metal features and parameters, respectively. The database parameter data 514 may provide parameters, which are stored in database (such as, standards like tools, material, part size, fasteners etc.). Similarly, additional parameter data modules can be provided for manufacturing processes.

Referring now to FIG. 6, a block diagram of an exemplary system 600 for executing DFX rules for 3D CAD models is illustrated, in accordance with some embodiments.

The system 600 may include a CAD application 601 including a DFMPro® plugin 602. Further, the system 600 may include a generic DFX rule validator 603, a parameter extractor 604, a rule definition reader 605, rule definition data 606, a module feature engine 607, a rule definition file 608 stored in a rule definition storage 609, and an expression evaluator 610.

A user may open the CAD application 601 and may launch the DFMPro® plugin 602 (an existing component of DFMPro® software) to perform DFX analysis. It should be noted that the user may refer to a subject matter expert or any other CAD user. The DFMPro® plugin 602 may provide required workflow and user interfaces to receive analysis inputs from the user. Additionally, the DFMPro® plugin 602 may perform analysis and may show DFM results to the user. The DFMPro® plugin 602 may use the generic DFX rule validator 603 to validate any DFX rule that may be created from a generic rule builder (such as, the generic DFX rule builder 103) and configured with a generic DFX rule configurator (such as, the generic DFX rule configurator 104).

The generic DFX rule validator 603 may read rule definition of the DFX rule being executed from the associated rule definition file 608 stored in the rule definition storage 609 and may populate the rule definition data 606. Further the generic DFX rule validator 603 may parse each of expressions defined in the rule definition data 606 to retrieve a list of features and associated parameters used to define rule logic. Further, the generic DFX rule validator 603 may extract each of the associated parameters through the parameter extractor 604 component from the respective module feature engines 607. By way of an example, the module feature engines 607 may include manufacturing process-specific engines 611 (such as, machining engine 612, injection molding engine 613, and sheet metal engine 614), CAD engine 615, or database engine 616. The manufacturing process-specific engines 611 may extract process-specific features and parameters. For example, the machining engine 612 may extract machining features and parameters, the injection molding engine 613 may extract injection molding features and parameters, the sheet metal engine 614 may extract sheet metal features and parameters from the CAD Model.

Upon extracting the associated parameters from the CAD Model being used in rule definition, the generic DFX rule validator 603 may evaluate each of the expressions with extracted value of parameters using the expression evaluator 610 and may compare the extracted values of each of the expressions with configured values using configured operators to check if any instance of a defined rule is failing. Upon identifying a failed instance, instances related information may be stored in generic result data and may be sent back to the DFMPro® plugin 602 to show DFM results to the user. Further, the generic DFX rule validator 603 may provide a storage mechanism to store the DFM result data in a generic and a common way for the DFX rules from different manufacturing processes, which may be presented in GUI of the DFMPro® plugin 602.

Referring now to FIG. 7, a block diagram of an exemplary system 700 for interactively modifying DFX rules for 3D CAD models is illustrated, in accordance with some embodiments.

The system 700 may include a DFX rule manager 701 including a rule builder GUI 702. Further, the system 700 may include a generic DFX rule builder 703, a parameter populator 704, a rule definition writer 705, rule definition data 706, a rule definition reader 707, a rule definition file stored in a rule definition storage 709, and module parameter data 710 (including, but not limited to, machining parameter data 711, injection molding parameter data 712, sheet metal parameter data 713, CAD parameter data 714, and database parameter data 715).

A DFX subject matter expert may launch the rule builder GUI 702 of the from the DFX rule manager 701. In some embodiments, the DFX rule manager 701 may be a standalone application. The rule builder GUI 702 may provide an option to modify rule definition of a selected DFX rule. First, the generic DFX rule builder 703 may read the rule definition data 706 for a selected rule with the help of the rule definition reader 707. The rule definition reader 707 may read the rule definition from the rule definition file 708 stored in the rule definition storage 709. The rule definition may include, but may not be limited to, rule name, module, description, summary, criticality, associated feature, help, rule image, and various expressions for rule definition and default configuration provided during rule creation. Further, the rule definition reader 707 may populate the rule definition in the rule builder GUI 702 from the generic DFX rule builder 703 which the framework supports. Further, the rule builder GUI 702 may store the rule definition in the rule definition data 706. Now, the rule definition (i.e., building blocks of the selected DFX rule) may be displayed to the user. The user may then modify any necessary information. Further, the modified information may be updated in the rule definition data 706. The updated rule definition data 706 may be written to the rule definition file 708 through the rule definition writer 705.

As will be also appreciated, the above described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

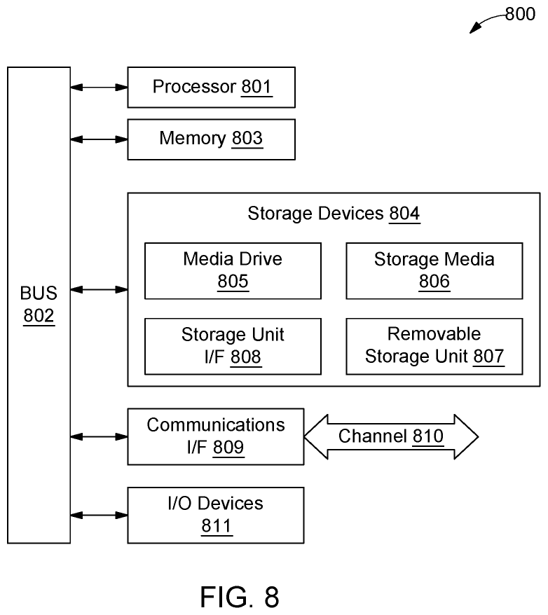

The disclosed methods and systems may be implemented on a conventional or a general-purpose computer system, such as a personal computer (PC) or server computer. Referring now to FIG. 8, an exemplary computing system 800 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 800 may represent, for example, a user device such as a desktop, a laptop, a mobile phone, personal entertainment device, DVR, and so on, or any other type of special or general-purpose computing device as may be desirable or appropriate for a given application or environment. The computing system 800 may include one or more processors, such as a processor 801 that may be implemented using a general or special purpose processing engine such as, for example, a microprocessor, microcontroller or other control logic. In this example, the processor 801 is connected to a bus 802 or other communication medium. In some embodiments, the processor 801 may be an Artificial Intelligence (AI) processor, which may be implemented as a Tensor Processing Unit (TPU), or a graphical processor unit, or a custom programmable solution Field-Programmable Gate Array (FPGA).

The computing system 800 may also include a memory 803 (main memory), for example, Random Access Memory (RAM) or other dynamic memory, for storing information and instructions to be executed by the processor 801. The memory 803 also may be used for storing temporary variables or other intermediate information during execution of instructions to be executed by the processor 801. The computing system 800 may likewise include a read only memory (“ROM”) or other static storage device coupled to bus 802 for storing static information and instructions for the processor 801.

The computing system 800 may also include a storage devices 804, which may include, for example, a media drive 805 and a removable storage interface. The media drive 805 may include a drive or other mechanism to support fixed or removable storage media, such as a hard disk drive, a floppy disk drive, a magnetic tape drive, an SD card port, a USB port, a micro USB, an optical disk drive, a CD or DVD drive (R or RW), or other removable or fixed media drive. A storage media 806 may include, for example, a hard disk, magnetic tape, flash drive, or other fixed or removable medium that is read by and written to by the media drive 805. As these examples illustrate, the storage media 806 may include a computer-readable storage medium having stored therein particular computer software or data.

In alternative embodiments, the storage devices 804 may include other similar instrumentalities for allowing computer programs or other instructions or data to be loaded into the computing system 800. Such instrumentalities may include, for example, a removable storage unit 807 and a storage unit interface 808, such as a program cartridge and cartridge interface, a removable memory (for example, a flash memory or other removable memory module) and memory slot, and other removable storage units and interfaces that allow software and data to be transferred from the removable storage unit 807 to the computing system 800.

The computing system 800 may also include a communications interface 809. The communications interface 809 may be used to allow software and data to be transferred between the computing system 800 and external devices. Examples of the communications interface 809 may include a network interface (such as an Ethernet or other NIC card), a communications port (such as for example, a USB port, a micro USB port), Near field Communication (NFC), etc. Software and data transferred via the communications interface 809 are in the form of signals which may be electronic, electromagnetic, optical, or other signals capable of being received by the communications interface 809. These signals are provided to the communications interface 809 via a channel 810. The channel 810 may carry signals and may be implemented using a wireless medium, wire or cable, fiber optics, or other communications medium. Some examples of the channel 810 may include a phone line, a cellular phone link, an RF link, a Bluetooth link, a network interface, a local or wide area network, and other communications channels.

The computing system 800 may further include Input/Output (I/O) devices 811. Examples may include, but are not limited to a display, keypad, microphone, audio speakers, vibrating motor, LED lights, etc. The I/O devices 811 may receive input from a user and also display an output of the computation performed by the processor 801. In this document, the terms “computer program product” and “computer-readable medium” may be used generally to refer to media such as, for example, the memory 803, the storage devices 804, the removable storage unit 807, or signal(s) on the channel 810. These and other forms of computer-readable media may be involved in providing one or more sequences of one or more instructions to the processor 801 for execution. Such instructions, generally referred to as “computer program code” (which may be grouped in the form of computer programs or other groupings), when executed, enable the computing system 800 to perform features or functions of embodiments of the present invention.

In an embodiment where the elements are implemented using software, the software may be stored in a computer-readable medium and loaded into the computing system 800 using, for example, the removable storage unit 807, the media drive 805 or the communications interface 809. The control logic (in this example, software instructions or computer program code), when executed by the processor 801, causes the processor 801 to perform the functions of the invention as described herein.

Thus, the disclosed method and system try to overcome the technical problem of interactively creating and managing DFX rules for 3D CAD models. The method and system allow subject matter experts, with no experience or knowledge in computer programming or scripting, to interactively build custom DFX rules. DFX Rules may be built in a few hours compared to conventional API-based approaches involving programming or scripting which may take one to couple of weeks depending on rule complexity. Cost of developing and maintaining DFX custom rules is reduced significantly by the disclosed method and system. Further, the method and system do not require use of development tools and knowledge to create DFX custom rules. Lead time for DFX custom rules development may be reduced significantly and DFX rules may be easily and quickly modified.

As will be appreciated by those skilled in the art, the techniques described in the various embodiments discussed above are not routine, or conventional, or well understood in the art. The techniques discussed above provide for interactively creating, configuring, validating, and managing DFX rules for 3D CAD models with no code. A DFX subject matter expert (who is essentially a non-programmer), can provide the identified rule definition information interactively to build and execute the rules through the techniques discussed above. The techniques may first receive, by a DFX rule builder, rule definition data corresponding to a DFX rule for a process associated with the 3D CAD model from a subject matter expert through a GUI. The techniques may then define, by the DFX rule builder, parameter expressions with a set of supported parameters for the process using a set of parameter data components of the process. The techniques may then generate, by a rule definition writer, a rule definition file for the DFX rule based on the rule definition data and the set of supported parameters obtained from the DFX rule builder.

In light of the above mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described method and system for interactively creating, executing, and managing DFX rules for 3D CAD models. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for interactively creating, executing, and managing Design for Excellence (DFX) rules for 3-Dimensional (3D) Computer Aided Design (CAD) models, the method comprising:
receiving, by a DFX rule builder, rule definition data corresponding to a DFX rule for a process associated with the 3D CAD model from a subject matter expert through a Graphical User Interface (GUI), wherein the rule definition data comprise basic details, definition criteria, and default configuration, and wherein each of the basic details, the definition criteria, and the default configuration comprise a plurality of data elements;
defining, by the DFX rule builder, parameter expressions with a set of supported parameters for the process using a set of parameter data components of the process; and
generating, by a rule definition writer, a rule definition file for the DFX rule based on the rule definition data and the set of supported parameters obtained from the DFX rule builder.

2. The method of claim 1, further comprising configuring, by a DFX rule configurator, the DFX rule using rule configuration data received from the subject matter expert, wherein the rule configuration data overwrites the default configuration of the DFX rule.

3. The method of claim 2, further comprising storing, by the rule definition writer, the rule definition file for the DFX rule in a database.

4. The method of claim 3, further comprising retrieving, by a rule definition reader, each of the rule definition data of the DFX rule from the rule definition file or the database.

5. The method of claim 2, further comprising:
parsing, by a DFX rule validator, each of the plurality of data elements defined in the rule definition data to obtain a list of features corresponding to the process and a set of associated parameters;
extracting, by the DFX rule validator, each of the set of associated parameters corresponding to the list of features from the 3D CAD model using a DFX feature and parameter extractor module; and
evaluating, by the DFX rule validator, each of the plurality of data elements based on the extracted set of associated parameters.

6. The method of claim 5, further comprising comparing, by the DFX rule validator, each of the plurality of data elements with each value of the rule configuration data using configured operators to identify one or more failed instances of the DFX rule.

7. The method of claim 6, further comprising displaying information associated with each of the one or more failed instances on the GUI.

8. The method of claim 1, further comprising:
receiving, by the DFX rule builder, modified rule definition data corresponding to the DFX rule from the subject matter expert through the GUI, wherein the modified rule definition data comprises a modification to at least one of the plurality of data elements of the rule definition data; and
modifying, by the DFX rule builder, the DFX rule based on the modified rule definition data.

9. A system for interactively creating, executing, and managing DFX rules for 3D CAD models, the system comprising:
a processor; and
a memory communicatively coupled to the processor, wherein the memory stores processor instructions, which when executed by the processor, cause the processor to:
receive, by a DFX rule builder, rule definition data corresponding to a DFX rule for a process associated with the 3D CAD model from a subject matter expert through a GUI, wherein the rule definition data comprise basic details, definition criteria, and default configuration, and wherein each of the basic details, the definition criteria, and the default configuration comprise a plurality of data elements;
define, by the DFX rule builder, parameter expressions with a set of supported parameters for the process using a set of parameter data components of the process; and
generate, by a rule definition writer, a rule definition file for the DFX rule based on the rule definition data and the set of supported parameters obtained from the DFX rule builder.

10. The system of claim 9, wherein the processor instructions, on execution, further cause the processor to configure, by a DFX rule configurator, the DFX rule using rule configuration data received from the subject matter expert, wherein the rule configuration data overwrites the default configuration of the DFX rule.

11. The system of claim 10, wherein the processor instructions, on execution, further cause the processor to store, by the rule definition writer, the rule definition file for the DFX rule in a database.

12. The system of claim 11, wherein the processor instructions, on execution, further cause the processor to retrieve, by a rule definition reader, each of the rule definition data of the DFX rule from the rule definition file or the database.

13. The system of claim 10, wherein the processor instructions, on execution, further cause the processor to:
parse, by a DFX rule validator, each of the plurality of data elements defined in the rule definition data to obtain a list of features corresponding to the process and a set of associated parameters;
extract, by the DFX rule validator, each of the set of associated parameters corresponding to the list of features from the 3D CAD model using a DFX feature and parameter extractor module; and
evaluate, by the DFX rule validator, each of the plurality of data elements based on the extracted set of associated parameters.

14. The system of claim 13, wherein the processor instructions, on execution, further cause the processor to compare, by the DFX rule validator, each of the plurality of data elements with each value of the rule configuration data using configured operators to identify one or more failed instances of the DFX rule.

15. The system of claim 14, wherein the processor instructions, on execution, further cause the processor to display information associated with each of the one or more failed instances on the GUI.

16. The system of claim 9, wherein the processor instructions, on execution, further cause the processor to:
receive, by the DFX rule builder, modified rule definition data corresponding to the DFX rule from the subject matter expert through the GUI, wherein the modified rule definition data comprises a modification to at least one of the plurality of data elements of the rule definition data; and
modify, by the DFX rule builder, the DFX rule based on the modified rule definition data.

17. A non-transitory computer-readable medium storing computer-executable instructions for interactively creating, executing, and managing DFX rules for 3D CAD models, the computer-executable instructions configured for:
receiving, by a DFX rule builder, rule definition data corresponding to a DFX rule for a process associated with the 3D CAD model from a subject matter expert through a GUI, wherein the rule definition data comprise basic details, definition criteria, and default configuration, and wherein each of the basic details, the definition criteria, and the default configuration comprise a plurality of data elements;
defining, by the DFX rule builder, parameter expressions with a set of supported parameters for the process using a set of parameter data components of the process; and
generating, by a rule definition writer, a rule definition file for the DFX rule based on the rule definition data and the set of supported parameters obtained from the DFX rule builder.

18. The non-transitory computer-readable medium of claim 17, wherein the computer-executable instructions are further configured for configuring, by a DFX rule configurator, the DFX rule using rule configuration data received from the subject matter expert, wherein the rule configuration data overwrites the default configuration of the DFX rule.

19. The non-transitory computer-readable medium of claim 18, wherein the computer-executable instructions are further configured for:
parsing, by a DFX rule validator, each of the plurality of data elements defined in the rule definition data to obtain a list of features corresponding to the process and a set of associated parameters;
extracting, by the DFX rule validator, each of the set of associated parameters corresponding to the list of features from the 3D CAD model using a DFX feature and parameter extractor module; and
evaluating, by the DFX rule validator, each of the plurality of data elements based on the extracted set of associated parameters.

20. The non-transitory computer-readable medium of claim 17, wherein the computer-executable instructions are further configured for:
receiving, by the DFX rule builder, modified rule definition data corresponding to the DFX rule from the subject matter expert through the GUI, wherein the modified rule definition data comprises a modification to at least one of the plurality of data elements of the rule definition data; and
modifying, by the DFX rule builder, the DFX rule based on the modified rule definition data.
